(19) United States
(12) Patent Application Publication
(10) Pub. No.: US 2025/0059006 A1
(43) Pub. Date: Feb. 20, 2025

(54) LIFT BAIL ASSEMBLY AND STRUCTURAL MEMBER FOR UNMANNED UNDERWATER VEHICLE

(71) Applicant: Naval Information Warfare Center Pacific, San Diego, CA (US)

(72) Inventors: Ralph David Hooper, Lemon Grove, CA (US); William Abott Chambers, Jamul, CA (US)

(73) Assignee: THE UNITED STATES OF AMERICA AS REPRESENTED BY THE SECRETARY OF THE NAVY, San Diego, CA (US)

(21) Appl. No.: 18/449,449

(22) Filed: Aug. 14, 2023

(51) Int. Cl. B66C 1/20; B63G 8/00

(52) U.S. Cl. CPC B66C 1/20; B63G 8/001; B63G 2008/002

(57) ABSTRACT

A lift bail assembly includes a lift bail frame, two distal lift clamps, two or more proximal lift clamps, and two stops. The lift bail frame includes an attachment cutout to attach the lift bail frame to a lifting device. The lift bail frame extends at least half of a body length of the unmanned underwater vehicle (UUV) where at least ⅔ of a weight of the UUV is directly supported by the lift bail. The two distal lift clamps are positioned opposite each other at each end of the lift bail frame. The two or more proximal lift clamps are positioned anywhere on the lift bail frame between the two distal lift clamps. The two stops fit into two stop cutouts on the UUV and are centered on the lift bail frame. All lift clamps that encompass the UUV are rigidly fixed to the lift bail frame.

### STATEMENT REGARDING FEDERALLY SPONSORED RESEARCH OR

DEVELOPMENT The invention described herein may be manufactured and used by or for the government of the United States of America for governmental purposes without the payment of any royalties thereon or therefor. Licensing and technical inquiries may be directed to the Office of Research and Technical Applications, Naval Information Warfare Center Pacific, Code 72120, San Diego, CA, 92152; (619) 553-5118; NIWC_Pacific_T2@us.navy.mil. Reference Navy Case Number 210531.

### BACKGROUND

Lift bails are typically used to lift an object from the center of that object while keeping the heavy object level during lifting. Lift bails can be incorporated into objects as part of their exterior design. Alternatively, lift bails can be removable, and therefore, can be added to and removed from objects. Similarly, lift bails may also be adjustable, and therefore, can be used on different sized objects. As a result, lift bails are used many different industries on difficult to lift objects.

### DESCRIPTION OF THE DRAWINGS

Features and advantages of examples of the present disclosure will be apparent by reference to the following detailed description and drawings, in which like reference numerals correspond to similar, but in some instances, not identical, components. Reference numerals or features having a previously described function may or may not be described in connection with other drawings in which they appear.

FIG. 1 is a perspective view of an example of a lift bail assembly described herein attached to the frame of a unmanned underwater vehicle;

FIG. 2 is a magnified perspective view of an example of the lift bail assembly showing the stops and stop cutouts;

FIG. 3 is a perspective view an example of a structural member described herein that is inserted and attached internally in an unmanned underwater vehicle; and

FIG. 4 is a perspective view of an example of the structural member attached to the internal wall and internal structure of an unmanned underwater vehicle.

### DETAILED DESCRIPTION

Some current unmanned underwater vehicles (UUVs) are not capable of being air lifted and deployed via an aerial vehicle unless the entire UUV is redesigned to have air lifting capabilities. This issue is apparent in legacy UUVs that are still operable, but were not designed originally designed for air lifting capabilities and aerial deployment. As a result, the legacy UUVs cannot be air lifted or deployed via an aerial vehicle without redesigning and modifying the legacy UUVs. Redesigning and modifying legacy UUVs would be costly and time consuming.

The lift bail assembly herein is designed to be attached or removed from any UUV. This includes applying the lift bail assembly to a legacy UUV originally not designed for airlifting or aerial deployment. Similarly, structural members are applied internally to UUVs to provide additional structural support for the frames of the UUVs. Additionally, the lift bail assembly allows the UUVs to be more easily lifted in general (e.g., removing the UUV from the water). Since the lift bail assembly and structural members can be added to any UUV, this negates the need to redesign or modify current UUVs, which reduces the cost and time to provide a UUV with airlifting capabilities.

The lift bail system herein includes a lift bail assembly and a structural member. The lift bail assembly includes a lift bail frame, two distal lift clamps, two or more proximal lift clamps, and two stop cutouts. The lift bail frame includes an attachment cutout to attach the lift bail assembly to a lifting device and the lift bail frame extends at least half of a body length of the unmanned underwater vehicle (UUV) where at least ⅔ of a weight of the UUV is directly supported by the lift bail assembly. The two distal lift clamps are positioned opposite each other at each end of the lift bail frame. The two or more proximal lift clamps are anywhere on the lift bail frame between the two distal lift clamps. The two stop cutouts are centered on the lift bail frame between the two or more proximal lift clamps. All lift clamps encompass the UUV and are rigidly fixed to the lift bail frame.

The structural member of the lift bail system herein includes a backing plate, a top mounting bracket, a starboard bracket, a port bracket, two bottom braces, the top cap, and two environmental anodes. The backing plate is rigidly fixed to an internal wall of the unmanned underwater vehicle. The top mounting bracket is rigidly fixed to the backing plate. The starboard sheet metal bracket is rigidly fixed to the top mounting bracket. The port bracket and top cap are rigidly fixed to the starboard bracket. The two bottom braces are located on a port side and a starboard side of the backing plate rigidly fixed to the backing plate. The two environmental anodes are rigidly fixed to the port bracket. The structural member is located internally within the UUV at one distal side or both distal sides of the UUV.

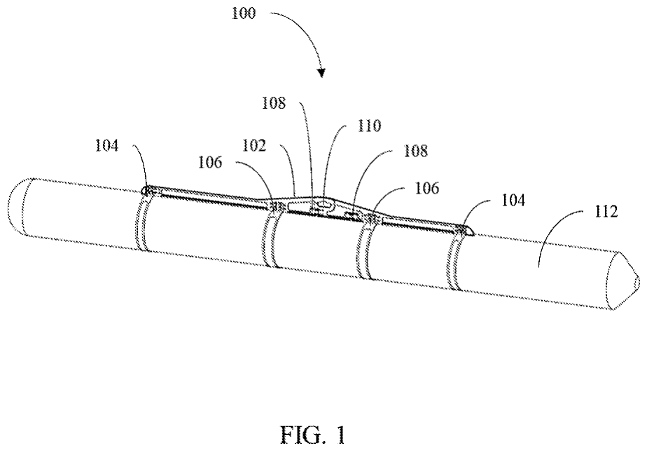

Referring now to FIG. 1, a perspective view of an example of a lift bail assembly 100 is shown. The lift bail assembly 100 includes a lift bail frame 102 extending on each side of the UUV 112. The lift bail frame 102 includes an attachment cutout 110 to attach the lift bail assembly to a lifting device. The attachment cutout 110 may be any size that allows the lifting device to attach to the lift bail 100. The lifting device may be anything that can lift the UUV 112 and using the lift bail assembly 100. Some examples of the lifting device include an aerial vehicle (e.g., a helicopter) or a crane vessel. The lift bail frame 102 extends at least half of a body length of the UUV 112 where at least ⅔ of a weight of the UUV 112 is directly supported by the lift bail assembly 100. In an example, the lift bail frame 102 is composed of aluminum, titanium, stainless steel, or a combination thereof.

Referring back to FIG. 1, the lift bail assembly 100 also includes two distal lift clamps 104 where the two distal lift clamps 104 are positioned opposite each other at each end of the lift bail frame 102. The two distal lift clamps 104 wrap around and encompass the UUV 112. In an example, the two distal lift clamps 104 are composed of aluminum, titanium, stainless steel, or a combination thereof. In an example, the two distal lift clamps 104 are rigidly fixed to the lift bail frame 102 with bolts, screws, rivets, welding, or a combination thereof.

Referring back to FIG. 1, the lift bail assembly 100 also includes two or more proximal lift clamps 106 where the two or more proximal lift clamps 106 are anywhere on the lift bail frame 102 between the two distal lift clamps 104. In the example shown in FIG. 1, there are two proximal lift clamps 106 between the two distal lift clamps 104. The two or more proximal lift clamps 106 wrap around and encompass the UUV 112. In an example, the two or more proximal lift clamps 106 are composed of aluminum, titanium, stainless steel, or a combination thereof. In an example, the two or more proximal lift clamps 106 are rigidly fixed to the lift bail frame 102 with bolts, screws, rivets, welding, or a combination thereof.

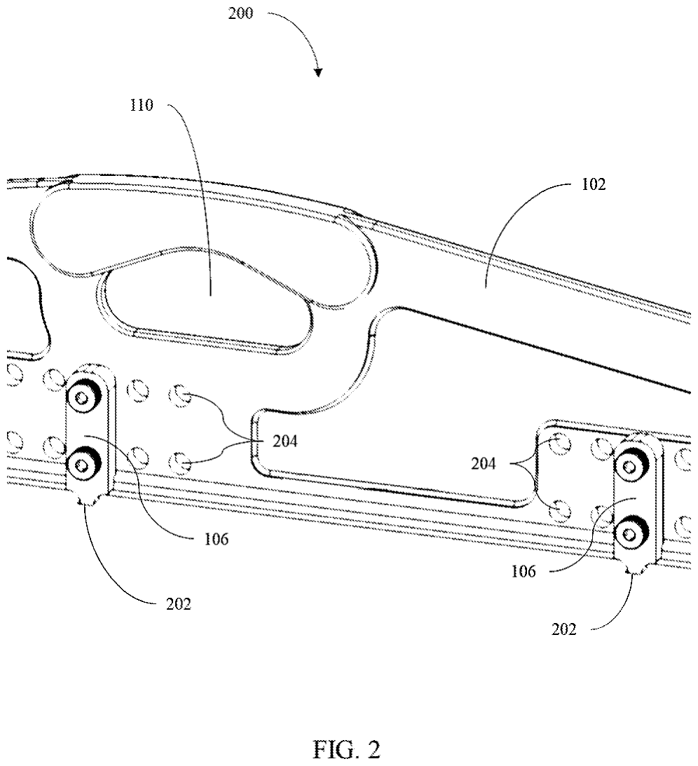

Referring now to FIG. 1 and FIG. 2, the lift bail assembly 100 includes two stops 108. The two stops 108 are centered on the lift bail frame 102 adjacent to the attachment cutout 110 on each side of the attachment cutout 110. The stops 108 prevent the UUV 112 from sliding on the lift bail assembly 100. In FIG. 2, an example of a magnified perspective view of the lift bail assembly 100 is shown with the stops 108 shown in more detail. The stop cutouts 108 are rigidly fixed the lift bail frame 102 using bolts, screws, rivets, welding, or a combination thereof. The UUV 112 has two or more stop cutouts 202 centered on the frame of the UUV 112. The stops 108 fit into the stop cutouts 202 to prevent the lift bail frame 102 from sliding. The lift bail frame 102 has additional stop attachment points 204 where the stops 108 can be attached at different points along the lift bail frame 102 depending on where the stop cutouts 202 are on the UUV 112.

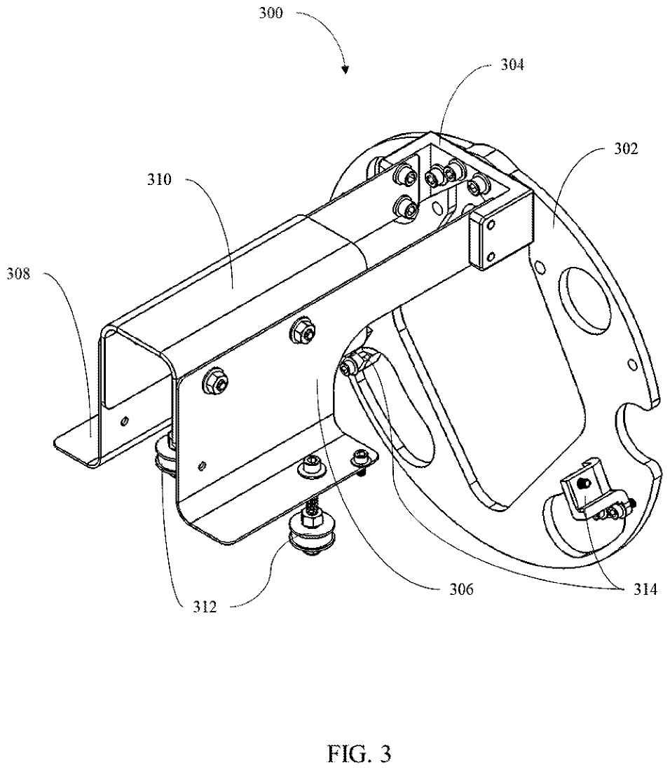

Referring now to FIG. 3, a perspective view of an example of the structural member 300 not attached to the UUV 112 is shown. The structural member 300 includes a backing plate 302 rigidly fixed to an internal wall of the UUV 402 (shown in FIG. 3). In an example, the backing plate 302 is composed of aluminum, titanium, stainless steel, or a combination thereof. The backing plate 302 is rigidly fixed to the internal wall of the UUV 402 using bolts, screws, rivets, welding, or a combination thereof.

Referring back to FIG. 3, the structural member 300 also includes a top mounting bracket 204 rigidly fixed to the backing plate 302. In an example, the top mounting bracket 304 is composed of aluminum, titanium, stainless steel, or a combination thereof. The top mounting bracket 304 is rigidly fixed to the backing plate 302 using bolts, screws, rivets, welding, or a combination thereof.

Referring back to FIG. 3, the structural member 300 also includes a starboard bracket 306, a port bracket 308, and a top cap 310. The starboard bracket 306 is rigidly fixed to the top mounting bracket 304 and the top cap 310. Similarly, the port bracket 308 is also rigidly fixed to the top mounting bracket 304 and the top cap 310. In an example, the starboard bracket 306, the port bracket 308, and the top cap 310 are composed of aluminum, titanium, stainless steel, or a combination thereof. The starboard bracket 306 and port bracket 308 are rigidly fixed to the mounting bracket 304 and the top cap 310 using bolts, screws, rivets, welding, or a combination thereof.

Referring back to FIG. 3, the structural member 300 further includes two environmental anodes 312 and two bottom braces 314. The environmental anodes 312 are sacrificial anodes used in the structural member 300 to prevent corrosion when the UUV 112 is used in salt water. The bottom braces 314 are located on a port side and a starboard side of the backing plate 302 rigidly fixed to the backing plate 302. One environmental anode 312 each is rigidly fixed to the starboard bracket 306 and the port bracket 308. In an example, the two bottom braces 314 are composed of aluminum, titanium, stainless steel, or a combination thereof. In an example, the two environmental anodes 312 and the two bottom braces 314 are rigidly fixed by bolts, screws, rivets, welding, or a combination thereof.

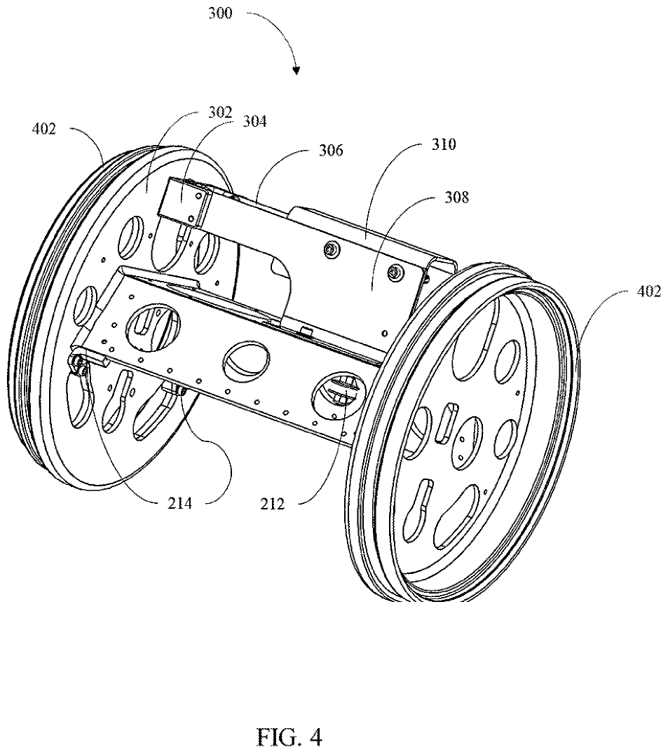

Referring now to FIG. 4, an example of a side view of a structural member rigidly fixed to an internal wall of a UUV 300 is shown. The structural member 300 is located internally within the UUV 112 at one distal side or both distal sides of the UUV 112. The structural member 300 is rigidly fixed to the internal wall of the UUV 402 on each side of the structural member 300. The structural member 300 is rigidly fixed to the internal wall of the UUV 402 via the backing plate 202 of the structural member 300. In an example, the structural member 300 is rigidly fixed to the internal wall of the UUV 402 using bolts, screws, rivets, welding, or a combination thereof.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of a list should be construed as a de facto equivalent of any other member of the same list merely based on their presentation in a common group without indications to the contrary.

Unless otherwise stated, any feature described herein can be combined with any aspect or any other feature described herein.

Reference throughout the specification to “one example”, “another example”, “an example”, means that a particular element (e.g., feature, structure, and/or characteristic) described in connection with the example is included in at least one example described herein, and may or may not be present in other examples. In addition, the described elements for any example may be combined in any suitable manner in the various examples unless the context clearly dictates otherwise.

The ranges provided herein include the stated range and any value or sub-range within the stated range. For example, a range from about 1 to about 20 should be interpreted to include not only the explicitly recited limits of from about 1 to about 20, but also to include individual values, such as 3, 7, 13.5, etc., and sub-ranges, such as from about 5 to about 15, etc.

In describing and claiming the examples disclosed herein, the singular forms “a”, “an”, and “the” include plural referents unless the context clearly dictates otherwise.

What is claimed is:

1. A lift bail assembly for an unmanned underwater vehicle, comprising:
a lift bail frame, wherein the lift bail frame includes an attachment cutout to attach the lift bail frame to a lifting device and the lift bail frame extends at least half of a body length of the unmanned underwater vehicle where at least ⅔ of a weight of the unmanned underwater vehicle is directly supported by the lift bail;
two distal lift clamps, wherein the two distal lift clamps are positioned opposite each other at each end of the lift bail frame;
two or more proximal lift clamps, wherein the two or more proximal lift clamps are positioned anywhere on the lift bail frame between the two distal lift clamps; and
two stops, wherein the two stops fit into two stop cutouts on the unmanned underwater vehicle and are centered on the lift bail frame adjacent to the attachment cutout;
wherein the two distal lift clamps and the two or more proximal lift clamps encompass the unmanned underwater vehicle and are rigidly fixed to the lift bail frame.

2. The lift bail assembly of claim 1, wherein the lift bail frame is composed of aluminum, titanium, stainless steel, or a combination thereof.

3. The lift bail assembly of claim 1, wherein the two distal lift clamps and the two or more proximal lift clamps are composed of aluminum, titanium, stainless steel, or a combination thereof.

4. The lift bail assembly of claim 1, wherein the two distal lift clamps and the two or more proximal lift clamps are rigidly fixed to the lift bail frame by bolts, screws, rivets, welding, or a combination thereof.

5. A structural member for strengthening an external structure of an unmanned underwater vehicle, comprising:
a backing plate, wherein the backing plate is rigidly fixed to an internal wall of the unmanned underwater vehicle;
a top mounting bracket, wherein the top mounting bracket is rigidly fixed to the backing plate;
a starboard bracket and a port bracket, wherein the starboard bracket and port bracket are rigidly fixed to the top mounting bracket and a top cap;
two bottom braces, wherein the two bottom braces are located on a port side and a starboard side of the backing plate rigidly fixed to the backing plate; and
two environmental anodes, wherein one environmental anode each is rigidly fixed to the starboard bracket and the port bracket;
wherein the structural member is located internally within the unmanned underwater vehicle at one distal side or both distal sides of the unmanned underwater vehicle.

6. The structural member of claim 5, wherein the starboard bracket and port bracket are composed of aluminum, titanium, stainless steel, or a combination thereof.

7. The structural member of claim 5, wherein the backing plate, the top mounting bracket, the two bottom braces, and the top cap are composed of aluminum, titanium, stainless steel, or a combination thereof.

8. The structural member of claim 5, wherein the backing plate, the top mounting bracket, the starboard bracket, the port bracket, the two environmental anodes, and the two bottom braces are rigidly fixed with bolts, screws, rivets, welding, or a combination thereof.

9. A lift attachment system for an unmanned underwater vehicle, comprising:
a lift bail assembly, wherein the lift bail assembly includes:
a lift bail frame, wherein the lift bail frame includes an attachment cutout to attach the lift bail frame to a lifting device and the lift bail frame extends at least half of a body length of the unmanned underwater vehicle where at least ⅔ of a weight of the unmanned underwater vehicle is directly supported below the lift bail;
two distal lift clamps, wherein the two distal lift clamps are positioned opposite each other at each end of the lift bail frame;
two or more proximal lift clamps, wherein the two or more proximal lift clamps are positioned anywhere on the lift bail frame between the two distal lift clamps; and
two stops, wherein the two stops fit into two stop cutouts on the unmanned underwater vehicle and are centered on the lift bail frame adjacent to the attachment cutout;
wherein the two distal lift clamps and the two or more proximal lift clamps encompass the unmanned underwater vehicle and are rigidly fixed to the lift bail frame;
one or more structural members, wherein the one or more structural members include:
a backing plate, wherein the backing plate is rigidly fixed to an internal wall of the unmanned underwater vehicle;
a top mounting bracket, wherein the top mounting bracket is rigidly fixed to the backing plate;
a starboard bracket and a port bracket, wherein the starboard bracket and port bracket are rigidly fixed to the top mounting bracket and a top cap;
two bottom braces, wherein the two bottom braces are located on a port side and a starboard side of the backing plate rigidly fixed to the backing plate; and
two environmental anodes, wherein one environmental anode each is rigidly fixed to the starboard bracket and the port bracket;
wherein the structural member is located internally within the unmanned underwater vehicle at one distal side or both distal sides of the unmanned underwater vehicle.

10. The system of claim 9, wherein the lift bail frame is composed of aluminum, titanium, stainless steel, or a combination thereof.

11. The system of claim 9, wherein the two distal lift clamps and the two or more proximal lift clamps are composed of aluminum, titanium, stainless steel, or a combination thereof.

12. The system of claim 9, wherein the two distal lift clamps and the two or more proximal lift clamps are secured to the lift frame by bolts, screws, rivets, welding, or a combination thereof.

13. The system of claim 9, wherein the starboard bracket and port bracket are composed of aluminum, titanium, stainless steel, or a combination thereof.

14. The system of claim 9, wherein the backing plate, the top mounting bracket, the two bottom braces, and the top cap are composed of aluminum, titanium, stainless steel, or a combination thereof.

15. The system of claim 9, wherein the backing plate, the top mounting bracket, the starboard bracket, the port bracket, the two environmental anodes, and the two bottom braces are rigidly fixed by bolts, screws, rivets, welding, or a combination thereof.
